(19) United States
(12) Patent Application Publication
(10) Pub. No.: US 2020/0091949 A1
(43) Pub. Date: Mar. 19, 2020

(54) SLIDING INTERMEDIATE-FREQUENCY RECEIVER

(71) Applicant: Atmosic Technologies Inc., Campbell, CA (US)

(72) Inventor: Manolis Terrovitis, Athens (GR)

(21) Appl. No.: 16/539,876

(22) Filed: Aug. 13, 2019

Related U.S. Application Data
(60) Provisional application No. 62/732,160, filed on Sep. 17, 2018.

(51) Int. Cl. H04B 1/26; H04B 1/10

(52) U.S. Cl. CPC H04B 1/26; H04B 1/1027

(57) ABSTRACT

This disclosure provides an apparatus for receiving and demodulating a radio frequency signal with a sliding intermediate frequency (IF) receiver. The sliding IF receiver may include a local oscillator (LO) and a clock divider, and a logic block. The clock divider may be configured to generate a first divided LO signal and a second divided LO signal based on an LO signal. The logic block may be configured to generate a first composite LO signal and a second composite LO signal. The first composite LO signal may be based on the first divided LO signal and the LO signal. The second composite LO signal may be based on the second divided LO signal and the LO signal. The first and the second composite LO signals may be used to demodulate a received RF signal and generate baseband signals.

### CROSS-REFERENCE TO RELATED APPLICATION

This application claims the benefit of co-pending and commonly owned U.S. Provisional Patent Application No. 62/732,160 entitled “SLIDING IF RECEIVER” filed on Sep. 17, 2018, the entirety of which is hereby incorporated by reference.

### TECHNICAL FIELD

The present disclosure generally relates to wireless devices, and specifically relates to sliding intermediate-frequency receivers used in wireless devices.

### BACKGROUND OF RELATED ART

Wireless devices (such as Wi-Fi devices, Bluetooth devices, wireless sensors, and IoT devices and the like) may transmit and receive radio-frequency (RF) communication signals. Some RF communication signals may be transmitted over a wireless medium using quadrature amplitude modulation (QAM) techniques. For example, wireless devices may use an in-phase (I) clock signal and a quadrature (Q) clock signal to encode and/or decode communication data into I components and Q components, respectively.

Some RF receivers, particularly intermediate-frequency (IF) RF receivers, may include a first mixer stage that uses a local oscillator (LO) signal to generate the IF signal, and may also include a second mixer stage that uses I and Q clock signals to generate baseband signals. These multiple mixer stages may increase design complexity and power consumption. In addition, the LO signal may face additional loading requirements associated with multiple mixer stages.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter described in this disclosure may be implemented as a sliding intermediate frequency (IF) receiver. The sliding IF receiver may include a clock divider and a logic block. The clock divider may receive a local oscillator (LO) signal, and may generate a first divided LO signal and a second divided LO signal based at least in part on the LO signal, wherein the first divided LO signal is offset with respect to the second divided LO signal. The logic block may generate a first composite LO signal based at least in part on the first divided LO signal and the LO signal, and may generate a second composite LO signal based at least in part on the second divided LO signal and the LO signal. In some aspects, the first composite LO signal may be based on a logical AND of the first divided LO signal and the LO signal, and the second composite LO signal may be based on a logical AND of the second divided LO signal and the LO signal. In some implementations, the sliding IF receiver may also include a first mixer configured to generate a first baseband signal based on a received RF signal and the first composite LO signal, and may also include a second mixer configured to generate a second baseband signal based on the received RF signal and the second composite LO signal.

Another innovative aspect of the subject matter described in this disclosure may be implemented in a wireless device. The wireless device may include an antenna configured to receive a radio-frequency (RF) signal, and may include a sliding intermediate frequency (IF) receiver. The sliding IF receiver may include an oscillator, a clock divider, logic block, a first mixer, and a second mixer. The oscillator may be configured to generate a local oscillator (LO) signal. The clock divider may be configured to generate a first divided LO signal and a second divided LO signal based on the LO signal. The logic block may be configured to generate a first composite LO signal based at least in part on the first divided LO signal and the LO signal, and may be configured to generate a second composite LO signal based at least in part on the second divided LO signal and the LO signal. The first mixer may be configured to generate an in-phase baseband signal based on the first composite LO signal, and the second mixer may be configured to generate a quadrature baseband signal based on the second composite LO signal. In some aspects, the first composite LO signal may be based on a logical AND of the first divided LO signal and the LO signal, and the second composite LO signal may be based on a logical AND of the second divided LO signal and the LO signal.

Another innovative aspect of the subject matter described in this disclosure may be implemented in a sliding intermediate frequency (IF) receiver. The sliding IF receiver may include means for receiving a local oscillator (LO) signal, and means for generating a first divided LO signal and a second divided LO signal based at least in part on the LO signal, wherein the first divided LO signal is offset with respect to the second divided LO signal. The sliding IF receiver may further include means for generating a first composite LO signal based at least in part on the first divided LO signal and the LO signal, and means for generating a second composite LO signal based at least in part on the second divided LO signal and the LO signal. In some implementations, the sliding IF receiver may also include means for generating a first baseband signal based on a received RF signal and the first composite LO signal, and may also include means for generating a second baseband signal based on the received RF signal and the second composite LO signal.

### BRIEF DESCRIPTION OF THE DRAWINGS

Aspects of the present disclosure are illustrated by way of example and are not intended to be limited by the figures of the accompanying drawings. Like numbers reference like elements throughout the drawings and specification.

FIG. 1 shows a block diagram of a conventional implementation of a receiver.

FIG. 2 depicts a wireless communication system within which aspects of the present disclosure may be implemented.

FIG. 3 shows an example sliding IF receiver, in accordance with some implementations.

FIG. 4 shows example waveforms associated with the sliding IF receiver of FIG. 3, in accordance with some implementations.

FIG. 5 shows another example sliding IF receiver, in accordance with some implementations.

FIG. 6 shows example waveforms associated with the sliding IF receiver of FIG. 5, in accordance with some implementations.

### DETAILED DESCRIPTION

Implementations of the subject matter described in this disclosure may be used to reduce the design complexity and power consumption of a sliding IF receiver. In some implementations, sliding IF receivers disclosed herein may generate in-phase and quadrature baseband signals from an RF signal and a local oscillator (LO) signal using only two mixers. Because each mixer consumes power and occupies valuable circuit area, the ability to generate in-phase and quadrature baseband signals in a sliding IF receiver may reduce power consumption and circuit area compared to conventional sliding IF receivers. Further, because signals generated by such mixers are susceptible to interference that can result in demodulation errors, the sliding IF receivers disclosed herein may be less susceptible to demodulation errors than conventional sliding IF receivers.

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

In the following description, numerous specific details are set forth such as examples of specific components, circuits, and processes to provide a thorough understanding of the disclosure. The term “coupled” as used herein means coupled directly to or coupled through one or more intervening components or circuits. Also, in the following description and for purposes of explanation, specific nomenclature is set forth to provide a thorough understanding of the example implementations. However, it will be apparent to one skilled in the art that these specific details may not be required to practice the example implementations. In other instances, well-known circuits and devices are shown in block diagram form to avoid obscuring the disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The example implementations are not to be construed as limited to specific examples described herein but rather to include within their scope all implementations defined by the appended claims.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory computer-readable storage medium comprising instructions that, when executed, performs one or more of the methods described below. The non-transitory computer-readable storage medium may form part of a computer program product, which may include packaging materials.

The various illustrative logical blocks, modules, circuits and instructions described in connection with the implementations disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general-purpose processor may be a microprocessor, but in the alternative, the processor may be any conventional processor, controller, microcontroller, or state machine. A processor may also be implemented as a combination of computing devices (such as a combination of a DSP and a microprocessor), a plurality of microprocessors, one or more microprocessors in conjunction with a DSP core, or any other suitable configuration.

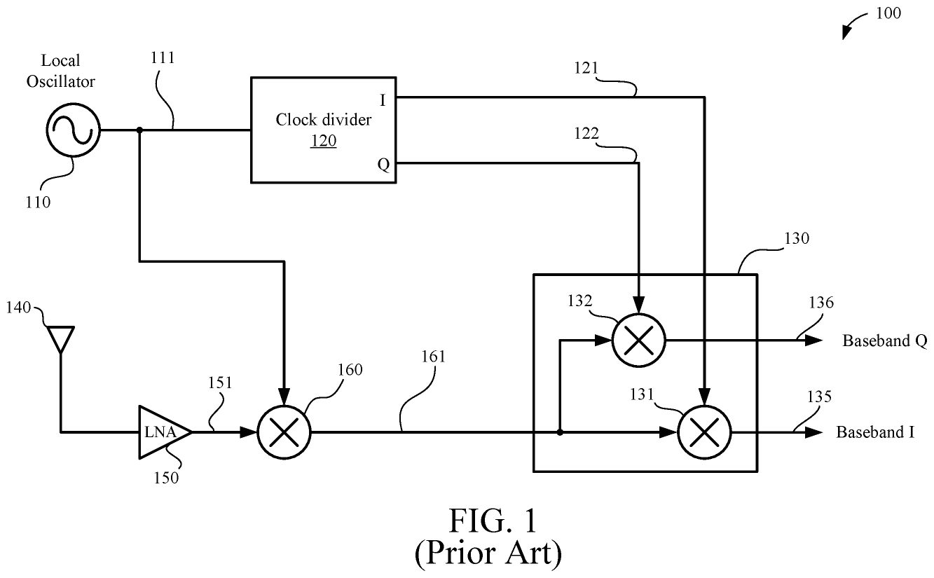

FIG. 1 shows a block diagram of a conventional implementation of a receiver 100. The receiver 100 may include a local oscillator (LO) 110, a clock divider 120, a mixer block 130, an antenna 140, a low noise amplifier (LNA) 150, and a first mixer 160. The LO 110 generates a LO signal 111 that is provided to the clock divider 120 and the first mixer 160. The first mixer 160 “mixes” the LO signal 111 with a radio-frequency (RF) signal 151 received through the antenna 140 and amplified through the LNA 150 to generate an intermediate frequency (IF) signal 161. Persons skilled in the art will appreciate that “mixing” by the first mixer 160 may correspond to generating signals with frequencies based on the sum and difference of the frequencies of input signals provided to the first mixer 160. Signal mixing may sometimes be referred to signal multiplying. Thus, the IF signal 161 may include signals with frequencies based on the sum and difference of the frequencies of the RF signal 151 and the LO signal 111.

The clock divider 120 may generate an in-phase (I) clock signal 121 and a quadrature (Q) clock signal 122 based on the LO signal 111. The in-phase clock signal 121 and the quadrature clock signal 122 may be related to the LO signal 111 by a divisor. The quadrature clock signal 122 may be offset from the in-phase clock signal 121 by ninety degrees. The in-phase clock signal 121 and the quadrature clock signal 122 are provided to the mixer block 130.

The mixer block 130 includes a second mixer 131 and a third mixer 132. The second mixer 131 receives the IF signal 161 and the in-phase clock signal 121, and generates an in-phase baseband signal 135. Similarly, the third mixer 132 receives the IF signal 161 and the quadrature clock signal 122, and generates a quadrature baseband signal 136.

Frequencies of the LO signal 111, the in-phase clock signal 121, and the quadrature clock signal 122 may be determined in part by a frequency plan to enable demodulation of the RF signal 151. For example, if the RF signal 151 is modulated with a 2.4 GHz carrier signal, then the LO signal 111 may have a frequency of 2.133 GHz to generate the IF signal 161 with a frequency of approximately 276 MHz (2.400 GHz−2.133 GHz=267 MHz). The in-phase clock signal 121 and the quadrature clock signal 122 may have a frequency of 267 MHz to allow the second mixer 131 and the third mixer 132 to generate baseband signals (e.g., signals having a frequency suitable for processing by a baseband processor). The receiver 100 is sometimes referred to as a sliding IF receiver because the frequency of the IF signal 161 “slides” or moves based on the RF signal 151.

The receiver 100 relies on three separate clock signals derived from the LO 110 to demodulate the RF signal 151 (e.g., the in-phase clock signal 121, the quadrature clock signal 122, and the clock signal 111). Each of these clock signals may “load” the LO 110, with each load requiring separate power. Further, each of these clock signals may be subject to interference, which in turn may separately result in demodulation errors. Moreover, the receiver 100 uses three mixers 131, 132, and 160 to demodulate the RF signal 151, with each of the mixers occupying valuable circuit area and having an associated power consumption.

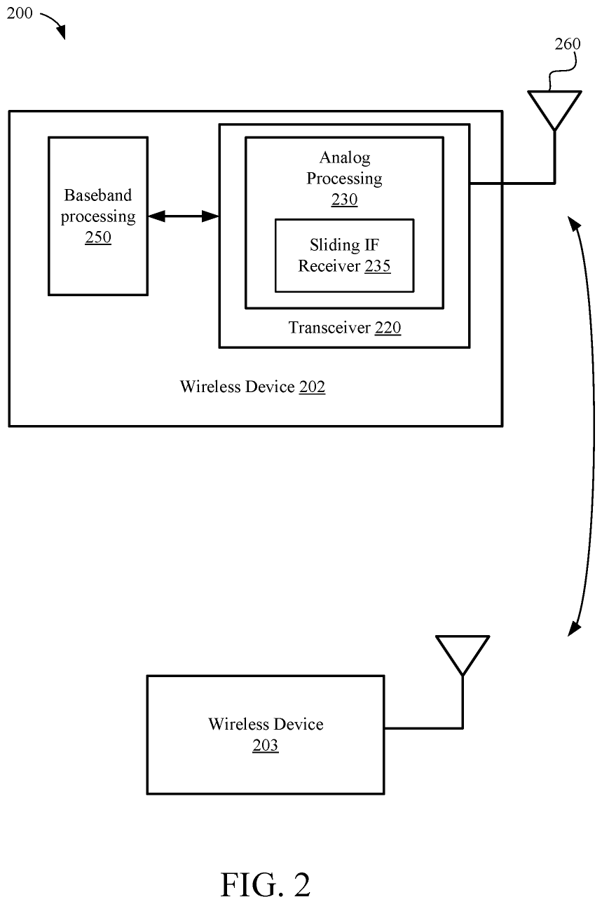

FIG. 2 depicts a wireless communication system 200 within which aspects of the present disclosure may be implemented. The wireless communication system 200 may include wireless devices 202 and 203. The wireless devices 202 and 203 may be any suitable wireless communication device. Example wireless communication devices may include a cell phone, personal digital assistant (PDA), tablet device, laptop computer, IoT device, or the like. The wireless devices 202 and 203 may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. Although only two wireless devices 202 and 203 are shown for simplicity, the wireless communication system 200 may include any number of wireless devices. In other implementations, the wireless communication system 200 may be a wired system and may include wired devices coupled to a wire or cable (not shown for simplicity). In still other implementations, the wireless communication system 200 may be a hybrid system and may include both wireless and wired communication devices.

The wireless devices 202 and 203 may communicate with each other via one or more technically feasible wireless communication protocols. In some implementations, the wireless devices 202 and 203 may communicate with each other (and with other devices not shown for simplicity) via Wi-Fi, Bluetooth®, Bluetooth Low Energy (BLE), Long Term Evolution (LTE), or any other suitable communication protocol. In some other implementations, the wireless devices 202 and 203 may operate within a 6 MHz, a 13 MHz, a 27 MHz, a 40 MHz, a 400 MHz, a 900 MHz, a 2.4 GHz, a 5 GHz, a 6 GHz, a 60 GHz or any other technically feasible frequency band. In another implementation, the wireless devices 202 and 203 may include one or more cellular transceivers that operate within various frequency bands (some of which may overlap with other frequency bands used by the wireless devices 202 and 203).

The wireless device 202 may include a transceiver 220, a baseband processing unit 250, and an antenna 260. Although not shown for simplicity, wireless device 202 may include one or more additional antennas, and may include other components such as (but not limited to) a user interface, memory, RF energy detection circuitry, energy harvesting circuitry, and an energy storage system. The baseband processing unit 250 may provide data to be transmitted to and/or may receive data from one or more other wireless devices via the transceiver 220 and the antenna 260. For example, the baseband processing unit 250 may encode communication data for transmission and/or may decode the communication data received by the transceiver 220.

The transceiver 220 may include an analog processing unit 230 coupled directly or indirectly to the antenna 260. The transceiver 220 may receive the communication data from and provide the communication data to the baseband processing unit 250 via the analog processing unit 230. In some implementations, the communication data may be processed according to a wireless communication protocol such as Wi-Fi, BLUETOOTH, near-field communication, Zig-Bee, or any other feasible wireless communication protocol. In other implementations, the communication data may be processed according to a wired protocol such as an Ethernet, Powerline Communication, or any other feasible wired communication protocol. In still other implementations, the communication data may be processed according to both a wireless and a wired communication protocol.

The analog processing unit 230 may provide analog processing to RF signals received from or provided to the antenna 260. For example, the analog processing unit 230 may demodulate an RF signal received via the antenna 260 from another wireless device (e.g., to recover data transmitted by the other wireless device). In some implementations, the analog processing unit 230 may include a sliding IF receiver 235 to demodulate RF signals, including quadrature amplitude modulated RF signals. The wireless device 203 may be similar to the wireless device 202 and include a transceiver and a baseband processing unit (not shown for simplicity).

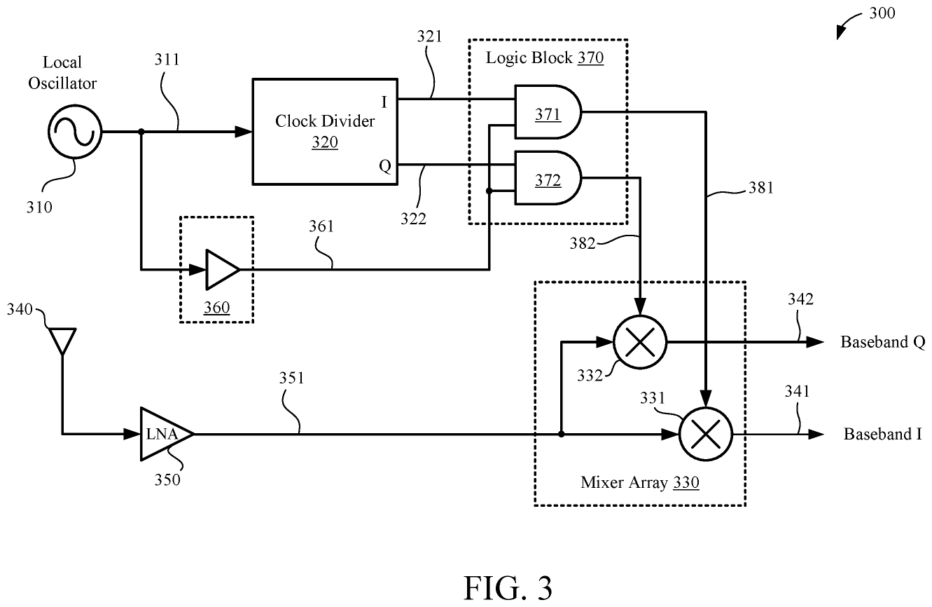

The sliding IF receiver 235 may receive the RF signal, generate a composite LO signal, and demodulate the RF signal based on the composite LO signal. In some implementations, the composite LO signal may be generated by a combination of an LO signal having a first frequency and one or more periodic quadrature signals having a second frequency. The composite LO signal may include both baseband and intermediate frequency components that enable the sliding IF receiver 235 to demodulate the RF signal using fewer mixers than the conventional receiver 100 of FIG. 1. The sliding IF receiver 235 is discussed in more detail below in conjunction with FIGS. 3-6.

FIG. 3 shows an example sliding IF receiver 300, in accordance with some implementations. The sliding IF receiver 300 may include an LO 310, a clock divider 320, a mixer array 330, an antenna 340, an LNA 350, an optional delay unit 360 (shown in dotted lines), and a logic block 370. In some implementations, the sliding IF receiver 300 may be an implementation of the sliding IF receiver 235 of FIG. 2.

The LO 310 may generate an LO signal 311. The LO 310 may be coupled to the clock divider 320. The clock divider 320 may divide the LO signal 311 by a divisor and may generate a first divided LO signal 321 and a second divided LO signal 322. In some implementations, the first divided LO signal 321 may be referred to as an in-phase clock signal and the second divided LO signal 322 may be referred to as a quadrature clock signal. While the first divided LO signal 321 and the second divided LO signal 322 may both be related to the LO signal 311 by a common divisor, in some implementations, the second divided LO signal 322 may be offset from the first divided LO signal 321 by ninety degrees.

The delay unit 360 (when present or enabled) may also be coupled to the LO 310. The delay unit 360 may generate a delayed LO signal 361 having a similar frequency and/or period as the LO signal 311, but delayed in time by a delay amount (or duration). In some implementations, the delay amount may be less than a clock period of the LO signal 311. In some aspects, the delay amount may be less than half a clock period of the LO signal 311. Although not shown for simplicity, in one or more implementations, the delay unit 360 may include a control terminal to receive an enable signal provided by memory or generated by a suitable processor (such as the analog processing unit 230 or the baseband processing unit 350 of FIG. 2). In some aspects, assertion of the enable signal may activate the delay unit 360 such that the delay unit 360 provides the delayed LO signal 361 to the logic block 370, and de-assertion of the enable signal may deactivate the delay unit 360 such that the delay unit 360 does not generate or provide the delayed LO signal 361 to the logic block 370.

In one or more other implementations, the sliding IF receiver 300 may include a bypass switch (not shown for simplicity) that can be used to bypass the delay unit 360 based on the enable signal. For example, when the enable signal is asserted, the bypass switch may be in a closed state and provide a signal path around the delay unit 360; conversely, when the enable signal is de-asserted, the bypass switch may be in an open state such that the delay unit 360 is connected between the LO 310 and the logic block 370 (e.g., such that the delay unit 360 provides the delayed LO signal 361 to the logic block 370).

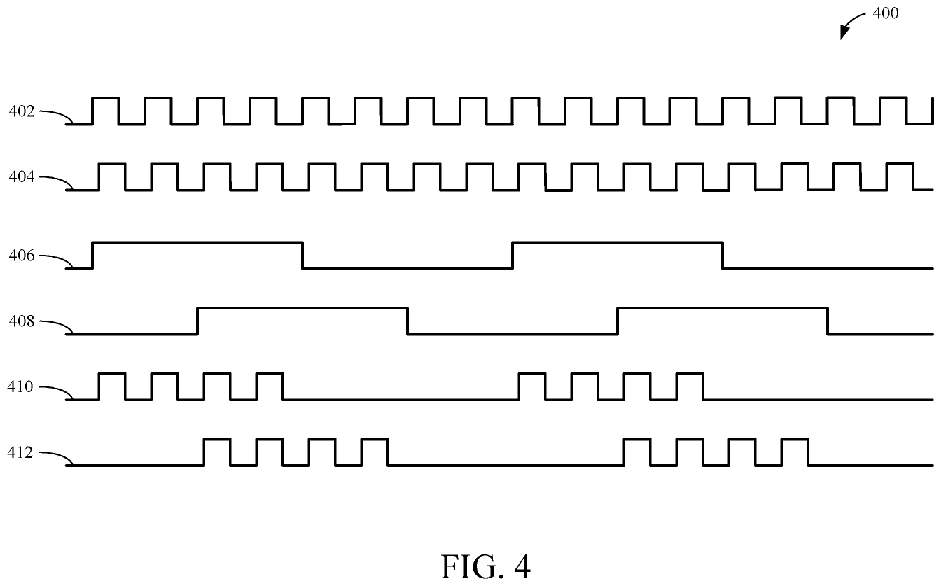

The logic block 370 may be coupled to the clock divider 320 and the delay unit 360. For implementations in which the delay unit 360 is omitted, the logic block 370 may be directly connected to the LO 310 rather than through the delay unit 360. The logic block 370 may combine the first divided LO signal 321 with the delayed LO signal 361 to generate a composite in-phase LO signal 381. In a similar manner, the logic block 370 may combine the second divided LO signal 322 with the delayed LO signal 361 to generate a composite quadrature LO signal 382. In some implementations, the first divided LO signal 321 may be combined with the delayed LO signal 361 through a logical AND function provided by a first AND gate 371, and the second divided LO signal 322 may be combined with the delayed LO signal 361 through a logical AND function provided by a second AND gate 372. Although illustrated with AND gates 371 and 372, the logic block 370 may implement the logical AND function through logic gates, discrete transistors, resistors, capacitors, or any through any other feasible devices. The composite in-phase LO signal 381 may include timing and/or frequency characteristics of the LO signal 311 and the first divided LO signal 321. Similarly, the composite quadrature LO signal 382 may include timing and/or frequency characteristics of the LO signal 311 and the second divided LO signal 322. The composite in-phase LO signal 381 and the composite quadrature LO signal 382 are described in more detail below in conjunction with FIG. 4.

The RF signal 351 may be received through the antenna 340 and amplified by the LNA 350. The mixer array 330 may be coupled to the LNA 350 and the logic block 370. The mixer array 330 may include a first mixer 331 to mix the RF signal 351 with the composite in-phase LO signal 381, and may include a second mixer 332 to mix the RF signal 351 with the composite quadrature LO signal 382. As discussed above, the first mixer 331 may generate an in-phase baseband signal 341 by multiplying the RF signal 351 with the composite in-phase LO signal 381, and the second mixer 332 may generate a quadrature baseband signal 342 by multiplying the RF signal 351 with the composite quadrature LO signal 382.

In some implementations, the first mixer 331 and the second mixer 332 may be implemented as switching mixers. For example, the first mixer 331 and the second mixer 332 may be implemented with voltage-controlled switches that may open and close in response to the composite in-phase LO signal 381 and the composite quadrature LO signal 382, respectively. Notably, the sliding IF receiver 300 may generate the in-phase baseband signal 341 and the quadrature baseband signal 342 using only two mixers, instead of using three mixers such as in the conventional receiver 100 of FIG. 1, and may therefore use less power and may be implemented using less die area than other receivers (such as the conventional receiver 100 of FIG. 1).

FIG. 4 shows example waveforms 400 associated with the sliding IF receiver 300, in accordance with some implementations. The waveforms 400 may include an LO signal 402, a delayed LO signal 404, a first divided LO signal 406, a second divided LO signal 408, a composite in-phase LO signal 410, and a composite quadrature LO signal 412.

The LO signal 402 is shown as a periodic square wave, but other implementations are possible. For example, the LO signal 402 may be a sine wave or any other feasible periodic waveform. Further, although shown as having a 50% duty cycle (equal high and low periods), the LO signal 402 may have any feasible duty cycle. The LO signal 402 may be an implementation of the LO signal 311 of FIG. 3. The delayed LO signal 404 may be similar to the LO signal 402, simply delayed by a fixed time period. The delay amount may be less than a clock period of the LO signal 402, and in some implementations much less than half a clock period of the LO signal 402. For example, the delayed LO signal 404 may be delayed by one or two percent of the clock period of the LO signal 402. In other implementations, the delayed LO signal 404 may be delayed with respect to the LO signal 402 by any feasible delay amount. The delayed LO signal 404 may enable generation of other signals (discussed below) while avoiding race conditions. The delayed LO signal 404 may be an implementation of the delayed LO signal 361.

The first divided LO signal 406 may be a periodic square wave signal based on the LO signal 402. As shown, the first divided LO signal 406 has a 50% duty cycle and is high for four LO signal 402 clock cycles and low for four LO signal 402 clock cycles. The period and duty cycle of the first divided LO signal 406 is illustrative and not meant to limit any implementation as other periods and duty cycles are possible. The second divided LO signal 408 may be similar to the first divided LO signal 406, but offset by 90 degrees. Thus, in the example waveforms 400, the second divided LO signal 408 is offset from the first divided LO signal 406 by two LO signal 402 clock cycles. The first divided LO signal 406 and the second divided LO signal 408 may be implementations of the first divided LO signal 321 and the second divided LO signal 322, respectively. In some implementations, the first divided LO signal 406 may be referred to as an in-phase clock signal and the second divided LO signal 408 may be referred to as a quadrature clock signal.

The composite in-phase LO signal 410 may be based on the delayed LO signal 404 and the first divided LO signal 406. In some implementations, the composite in-phase LO signal 410 may be generated though a logical AND operation between the delayed LO signal 404 and the first divided LO signal 406. Thus, the composite in-phase LO signal 410 includes the delayed LO signal 404 clock pulses when the first divided LO signal 406 is high (a logical one). In other implementations, the first divided LO signal 406 may be asserted in a low state (a logical zero). Therefore, the composite in-phase LO signal 410 may include the delayed LO signal 404 clock pulses when the first divided LO signal 406 is a logical zero. In this manner, the composite in-phase LO signal 410 includes timing and/or frequency characteristics of both the LO signal 402 and the first divided LO signal 406. The composite in-phase LO signal 410 may be an implementation of the composite in-phase LO signal 381 and may be used to demodulate a quadrature modulated RF signal.

In a similar manner, the composite quadrature LO signal 412 may be based on the delayed LO signal 404 and the second divided LO signal 408. Thus, the composite quadrature LO signal 412 may be generated through a logical AND operation between the delayed LO signal 404 and the second divided LO signal 408 and may include timing and/or frequency characteristics of both the LO signal 402 and the second divided LO signal 408. The composite quadrature LO signal 412 may be an implementation of the composite quadrature LO signal 382 and also may be used to demodulate a quadrature modulated RF signal.

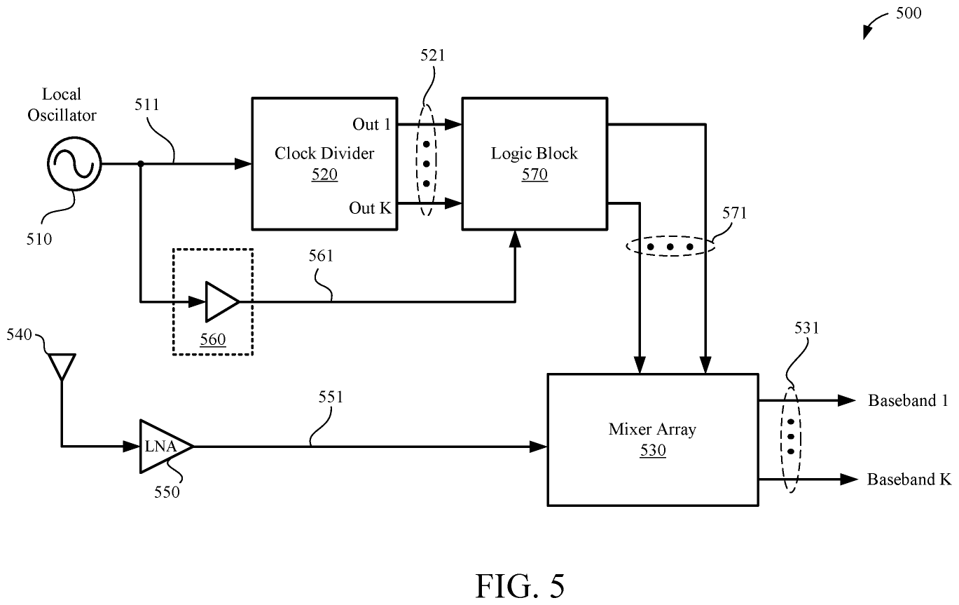

FIG. 5 shows another example sliding IF receiver 500, in accordance with some implementations. The sliding IF receiver 500 may include an LO 510, a clock divider 520, a mixer array 530, an antenna 540, an LNA 550, an optional delay unit 560 (shown in dotted lines), and a logic block 570. In some implementations, the sliding IF receiver 500 may be an implementation of the sliding IF receiver 235 of FIG. 2.

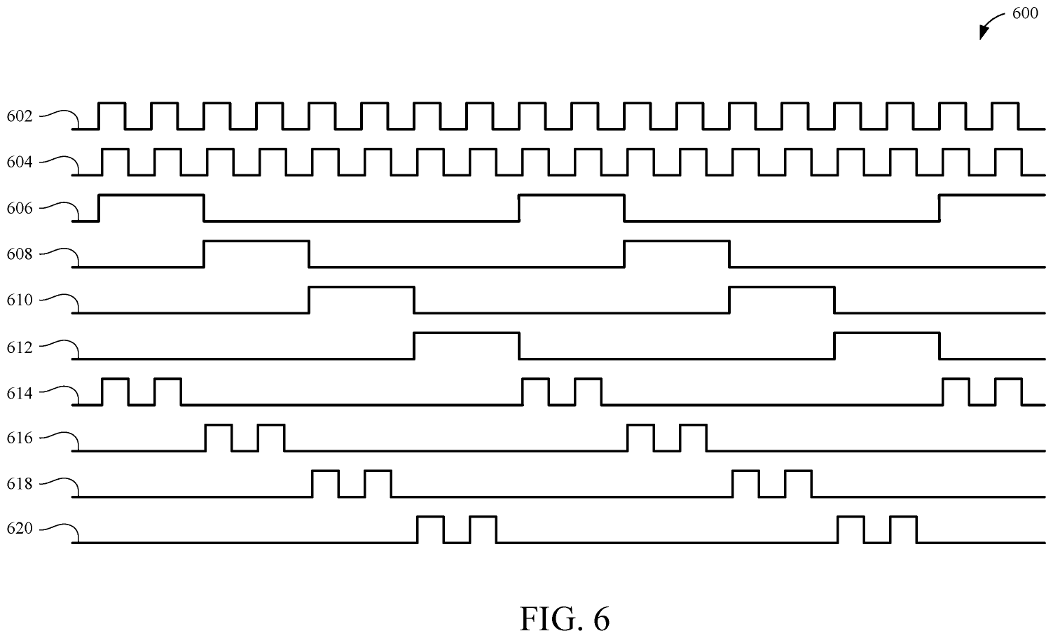

The LO 510 may generate an LO signal 511. The LO 510 may be coupled to the clock divider 520. The clock divider 520 may be a generalized implementation of the clock divider 320 of FIG. 3 that can generate up to K divided LO signals 521 (where K=2ⁿ and n is a non-zero positive integer) based on the LO signal 511. In contrast to the first divided LO signal 321 and the second divided LO signal 322, each of the up to K divided LO signals 521 may be non-overlapping, for example, as described in greater detail below in conjunction with FIG. 6.

The delay unit 560 (when present or enabled) may also be coupled to the LO 510. The delay unit 560 may generate a delayed LO signal 561 having a similar frequency and/or period with respect to the LO signal 511, but delayed in time by a delay amount (or duration). In some implementations, the delay amount may be less than a clock period of the LO signal 511. In some aspects, the delay amount may be less than half a clock period of the LO signal 511. Although not shown for simplicity, in one or more implementations, the delay unit 560 may include a control terminal to receive an enable signal provided by memory or generated by a suitable processor (such as the analog processing unit 230 or the baseband processing unit 350 of FIG. 2). In some aspects, assertion of the enable signal may activate the delay unit 560 such that the delay unit 560 provides the delayed LO signal 561 to the logic block 570, and de-assertion of the enable signal may deactivate the delay unit 560 such that the delay unit 560 does not generate or provide the delayed LO signal 561 to the logic block 570.

In one or more other implementations, the sliding IF receiver 500 may include a bypass switch (not shown for simplicity) that can be used to bypass the delay unit 560 based on the enable signal. For example, when the enable signal is asserted, the bypass switch may be in a closed state and provide a signal path around the delay unit 560; conversely, when the enable signal is de-asserted, the bypass switch may be in an open state such that the delay unit 560 is connected between the LO 510 and the logic block 570 (e.g., such that the delay unit 560 provides the delayed LO signal 561 to the logic block 570).

The logic block 570 may be coupled to the clock divider 520 and the delay unit 560. For implementations in which the delay unit 560 is omitted, the logic block 570 may be directly connected to the LO 510 rather than through the delay unit 560. The logic block 570 may separately combine each of the up to K divided LO signals 521 with the delayed LO signal 561 to generate up to K composite divided LO signals 571. In some implementations, each of the up to K divided LO signals 521 may be combined with the delayed LO signal 561 through a logical AND function. Each of the up to K composite divided LO signals 571 may feature timing and/or frequency characteristics of both the LO signal 511 and at least one of the up to K divided LO signals 521. The up to K composite divided LO signals 571 are described in more detail below in conjunction with FIG. 6.

The RF signal 551 may be received through the antenna 540 and amplified by the LNA 550. The mixer array 530 may be coupled to the LNA 550 and the logic block 570. The mixer array 530 may include up to K mixers (not shown for simplicity) to mix the RF signal 551 with each of the up to K composite divided LO signals 571. As a result, the mixer array 530 may generate up to K baseband signals 531.

FIG. 6 shows example waveforms 600 associated with the sliding IF receiver 500, in accordance with an implementation where K=4. The waveforms 600 may include an LO signal 602, a delayed LO signal 604, a first divided LO signal 606, a second divided LO signal 608, a third divided LO signal 610, a fourth divided LO signal 612, a first composite divided LO signal 614, a second composite divided LO signal 616, a third composite divided LO signal 618, and a fourth composite divided LO signal 620.

The LO signal 602 may be an implementation of the LO signal 511 of FIG. 5. Similarly, the delayed LO signal 604 may be an implementation of the delayed LO signal 561. The first divided LO signal 606 may be based on the LO signal 602. In this example, the first divided LO signal 606 may be high (a logical one) for two LO signal 602 clock cycles, but other high durations are possible. In some implementations, the duty cycle of the first divided LO signal 606 is (1/K)*(100) %. Thus, since K=4, the duty cycle of the first divided LO signal 606 is 25%. Since the first divided LO signal 606 is high for two LO signal 602 clock cycles, the high duration of the other divided LO signals 608, 610, and 612 is also two LO signal 602 clock cycles.

The second divided LO signal 608 is shown as having the same duration as the first divided LO signal 606, but asserted (a logical one) when the first divided LO signal 606 is de-asserted (a logical zero). In a similar manner, the third divided LO signal 610 is asserted as the second divided LO signal 608 is de-asserted and the fourth divided LO signal 612 is asserted as the third divided LO signal 610 is de-asserted. In this manner K staggered, non-overlapping divided LO signals are generated.

The first composite divided LO signal 614 may be generated through a logical AND operation between the delayed LO signal 604 and the first divided LO signal 606. Similarly, the second composite divided LO signal 616 may be generated through a logical AND operation between the delayed LO signal 604 and the second divided LO signal 608, the third composite divided LO signal 618 may be generated through a logical AND operation between the delayed LO signal 604 and the third divided LO signal 610, and the fourth composite divided LO signal 620 may be generated through a logical AND operation between the delayed LO signal 604 and the fourth divided LO signal 612. The composite divided LO signals 614, 616, 618, and 620 may be used to generate K baseband signals.

In the foregoing specification, the example implementations have been described with reference to specific exemplary implementations thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A sliding intermediate frequency (IF) receiver comprising:
a clock divider configured to:
receive a local oscillator (LO) signal;
generate a first divided LO signal and a second divided LO signal based at least in part on the LO signal, wherein the first divided LO signal is offset with respect to the second divided LO signal; and
a logic block configured to:
generate a first composite LO signal based at least in part on the first divided LO signal and the LO signal; and
generate a second composite LO signal based at least in part on the second divided LO signal and the LO signal.

2. The sliding IF receiver of claim 1, wherein the first composite LO signal is based on a logical AND of the first divided LO signal and the LO signal, and the second composite LO signal is based on a logical AND of the second divided LO signal and the LO signal.

3. The sliding IF receiver of claim 1, wherein the second divided LO signal is ninety degrees delayed with respect to the first divided LO signal.

4. The sliding IF receiver of claim 1, further comprising a delay element configured to provide a delayed LO signal to the logic block.

5. The sliding IF receiver of claim 1, further comprising:
an input to receive a radio-frequency (RF) signal;
a first mixer configured to generate a first baseband signal based on the received RF signal and the first composite LO signal; and
a second mixer configured to generate a second baseband signal based on the received RF signal and the second composite LO signal.

6. The sliding IF receiver of claim 1, wherein the clock divider is further configured to:
generate up to K divided clock signals, where K=2ⁿ and n is a non-zero positive integer.

7. The sliding IF receiver of claim 6, wherein each of the up to K divided clock signals is non-overlapping and has a duty cycle of (1/K)*100%.

8. The sliding IF receiver of claim 7, further comprising up to K mixers coupled to each of the up to K divided clock signals configured to generate up to K baseband signals.

9. A wireless device comprising:
an antenna configured to receive a radio-frequency (RF) signal; and
a sliding intermediate frequency (IF) receiver comprising:
an oscillator configured to generate a local oscillator (LO) signal;
a clock divider configured to generate a first divided LO signal and a second divided LO signal based on the LO signal;
a logic block configured to:
generate a first composite LO signal based at least in part on the first divided LO signal and the LO signal; and
generate a second composite LO signal based at least in part on the second divided LO signal and the LO signal;
a first mixer coupled to the antenna and configured to generate an in-phase baseband signal based on the first composite LO signal and the RF signal; and
a second mixer coupled to the antenna and configured to generate a quadrature baseband signal based on the second composite LO signal and the RF signal.

10. The wireless device of claim 9, wherein the first composite LO signal is based on a logical AND of the first divided LO signal and the LO signal, and the second composite LO signal is based on a logical AND of the second divided LO signal and the LO signal.

11. The wireless device of claim 9, wherein the first divided LO signal and the second divided LO signal have a quadrature relationship.

12. The wireless device of claim 9, further comprising a delay element configured to provide a delayed LO signal to the logic block.

13. The wireless device of claim 9, wherein the first composite LO signal includes frequency characteristics of the LO signal and the first divided LO signal, and the second composite LO signal includes frequency characteristics of the LO signal and the second divided LO signal.

14. The wireless device of claim 9, further comprising a delay element configured to provide a delayed LO signal to the logic block.

15. The wireless device of claim 9, wherein the clock divider is further configured to:
generate up to K divided clock signals, where K=2ⁿ and n is a non-zero positive integer.

16. A sliding intermediate frequency (IF) receiver comprising:
means for receiving a local oscillator (LO) signal;
means for generating a first divided LO signal and a second divided LO signal based at least in part on the LO signal, wherein the first divided LO signal is offset with respect to the second divided LO signal;
means for generating a first composite LO signal based at least in part on the first divided LO signal and the LO signal; and
means for generating a second composite LO signal based at least in part on the second divided LO signal and the LO signal.

17. The sliding IF receiver of claim 16, wherein the first composite LO signal is based on a logical AND of the first divided LO signal and the LO signal, and the second composite LO signal is based on a logical AND of the second divided LO signal and the LO signal.

18. The sliding IF receiver of claim 16, wherein the second divided LO signal is ninety degrees delayed with respect to the first divided LO signal.

19. The sliding IF receiver of claim 16, further comprising:
means for receiving a radio-frequency (RF) signal;
means for generating a first baseband signal based on the received RF signal and the first composite LO signal; and
means for generating a second baseband signal based on the received RF signal and the second composite LO signal.

20. The sliding IF receiver of claim 16, further comprising:
means for generating up to K divided clock signals, wherein each of the up to K divided clock signals is non-overlapping and has a duty cycle of (1/K)*100%, where K=2ⁿ and n is a non-zero positive integer.
